(19) United States
(12) Patent Application Publication
(10) Pub. No.: US 2025/0018942 A1
(43) Pub. Date: Jan. 16, 2025

(54) VEHICLE CONTROL DEVICE AND METHOD

(71) Applicant: DENSO CORPORATION, Kariya-city (JP)

(72) Inventor: Hidetoshi SUZUKI, Kariya-city (JP)

(73) Assignee: DENSO CORPORATION, Kariya-city (JP)

(21) Appl. No.: 18/899,249

(22) Filed: Sep. 27, 2024

Related U.S. Application Data
(63) Continuation of application No. PCT/JP2023/007867, filed on Mar. 2, 2023.

(30) Foreign Application Priority Data
Mar. 28, 2022 (JP) 2022-052567

(51) Int. Cl. B60W 30/14; B60W 10/08; B60W 10/20

(52) U.S. Cl. CPC B60W 30/143; B60W 10/08; B60W 10/20; B60W 2520/10; B60W 2520/14; B60W 2530/10; B60W 2530/20; B60W 2710/081

(57) ABSTRACT

A vehicle includes a vehicle body, drive wheels that are mounted to the vehicle body at two positions, which are right and left positions with respect to a traveling direction, and respectively have motors, and steerable driven wheels mounted to the vehicle body. A vehicle control device controls drive of the motors to control travel of the vehicle. The vehicle control device includes a thrust calculation unit that calculates a thrust produced by rotation of the motors at the drive wheels when the vehicle travels on a predetermined path, a center of gravity calculation unit that calculates a position of a center of gravity of the vehicle in a coordinate system whose origin is a center position between the drive wheels, based on the thrust, and a control unit that controls rotational speeds or moving velocities of the drive wheels based on the position of the center of gravity.

### CROSS-REFERENCE TO RELATED APPLICATION

The present application is based on and claims the benefit of priority from earlier Japanese Patent Application No. 2022-052567 filed on Mar. 28, 2022, the description of which is incorporated herein by reference.

### BACKGROUND

### Technical Field

The present disclosure relates to a vehicle control device and a method that control travel of a vehicle including a pair of drive wheels independently driven.

### RELATED ART

Conventionally, vehicles are known which are used for, for example, conveying goods, and in which motors are respectively mounted to a plurality of wheels, which are independently driven, whereby the vehicles can travel on desired traveling paths. In addition, a technique is known which estimates vehicle parameters such as weight and the position of the center of gravity of the vehicle 20 from the fact that the parameters vary depending on the state of loading of goods or the like.

### SUMMARY

An aspect of the present disclosure is a vehicle control device that is applied to a vehicle including: a vehicle body; a pair of drive wheels that are mounted to the vehicle body at two positions, which are right and left positions with respect to a traveling direction, and respectively have motors that are independently driven; and steerable driven wheels mounted to the vehicle body, the vehicle control device 30 controlling drive of the motors of the drive wheels to control travel of the vehicle,
the vehicle control device including:
a thrust calculation unit that calculates a thrust produced by rotation of the motors at the drive wheels when the vehicle travels on a predetermined path;
a center of gravity calculation unit that calculates a position of a center of gravity of the vehicle in a coordinate system whose origin is a center position between the pair of drive wheels, based on the thrust calculated by the thrust calculation unit; and
a control unit that controls rotational speeds or moving velocities of the drive wheels based on the position of the center of gravity.

### BRIEF DESCRIPTION OF THE DRAWINGS

In the accompanying drawings:

FIG. 1 is a diagram illustrating a schematic diagram of a vehicle;

FIG. 2 is a diagram illustrating parameters of the vehicle;

FIG. 3 is a block diagram illustrating an overview of functions performed by a control device;

FIG. 4 is a diagram illustrating a state in which the vehicle turns;

FIG. 5 is a diagram illustrating an overview of calculation of weight and a position of the center of gravity in the horizontal direction;

FIG. 6 is a diagram illustrating an overview of calculation of a position of the center of gravity in the longitudinal direction;

FIG. 7 is a diagram illustrating an overview of calculation of inertia;

FIG. 8 is a flowchart of a procedure of calculating the parameters;

FIG. 9 is a diagram illustrating a relationship used for calculating the position of the center of gravity;

FIG. 10 is a flowchart of a procedure of vehicle travel control;

FIG. 11 is a flowchart of a procedure of travel control performed when the vehicle changes direction; and

FIG. 12 is a diagram illustrating a vehicle having another configuration.

### DETAILED DESCRIPTION OF THE PREFERRED EMBODIMENTS

Conventionally, vehicles are known which are used for, for example, conveying goods, and in which motors are respectively mounted to a plurality of wheels, which are independently driven, whereby the vehicles can travel on desired traveling paths. In addition, a technique is known which estimates vehicle parameters such as weight and the position of the center of gravity of the vehicle from the fact that the parameters vary depending on the state of loading of goods or the like. For example, according to the technique described in JP 2021-168532 A, in a vehicle having a plurality of wheels, which are right and left front wheels and right and left rear wheels, torque generators of the front wheels are caused to rotate in the same direction, and torque generators of the rear wheels are caused to rotate in opposite directions, thereby estimating the position of the center of gravity in the longitudinal direction of the vehicle based on rotation angles of the front wheels and the rear wheels.

According to the above technique described in JP 2021-168532 A, when the position of the center of gravity of the vehicle is estimated, torque is required to be generated in the front wheels and the rear wheels in opposite directions. To implement the technique, the vehicle structure is constrained, for example, drive wheels are required at the front and the rear of the vehicle. For example, in the vehicle including two right and left drive wheels and two right and left driven wheels, the position of the center of gravity of the vehicle cannot be estimated. In addition, if the position of the center of gravity of the vehicle cannot be determined, problems such as load imbalance of goods are concerned when the vehicle travels.

In view of the above points, the present disclosure has an object of providing a vehicle control device and a method by which, in a vehicle including an independently driven pair of drive wheels and steerable driven wheels, a position of the center of gravity of the vehicle can be suitably calculated, whereby the vehicle can be caused to appropriately travel.

Hereinafter, an embodiment will be described with reference to the drawings. A vehicle of the present embodiment is an electric mobility (autonomous travel vehicle) that can autonomously travel using rotation of a pair of drive wheels and can be used as, for example, an automated guided vehicle conveying goods. Alternatively, the vehicle can be used as a guided vehicle used for conveying persons, animals, or the like. It is noted that, in the following embodiment, parts identical or equivalent to each other are indicated by the same reference signs in the drawings to omit redundant descriptions.

### First Embodiment

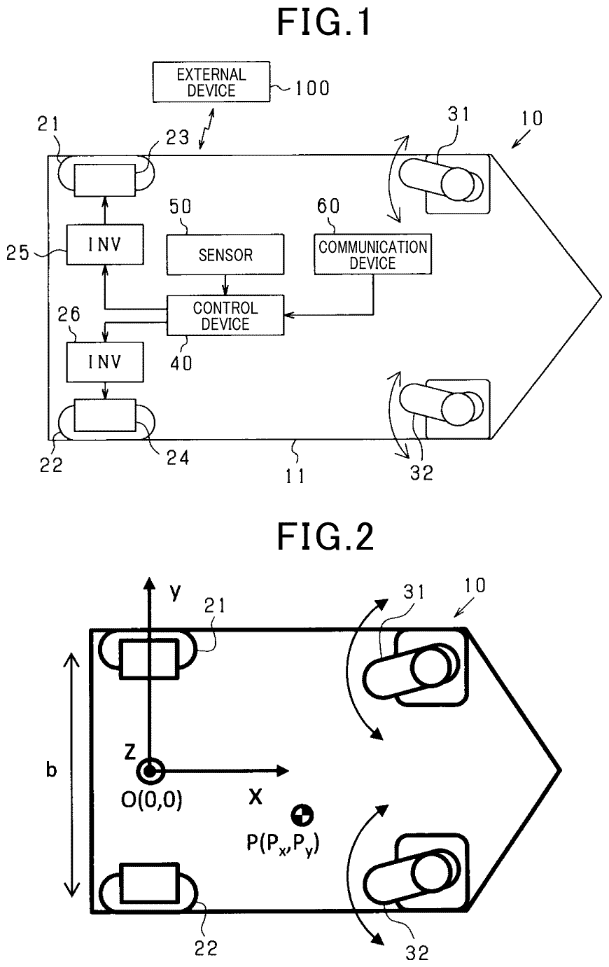

A vehicle 10 according to the present embodiment is an automated guided vehicle used for conveying goods in an automated warehouse. An overview of the vehicle 10 is illustrated in FIG. 1.

In FIG. 1, the vehicle 10 includes a vehicle body 11, a pair of drive wheels 21, 22 and a pair of driven wheels 31, 32. The pair of drive wheels 21, 22 is mounted at two positions (right and left positions) in the direction orthogonal to the traveling direction of the vehicle 10 and is independently driven. The pair of driven wheels 31, 32 rotates depending on the rotation of the drive wheels 21, 22 and can be steered 15 freely.

The drive wheels 21, 22 are so-called in-wheel motors respectively having motors 23, 24 as driving sources. The vehicle 10 is provided with inverters 25, 26 for motors 23, 24, respectively. The drive wheels 21, 22 may integrally have the motors 23, 24 and the inverters 25, 26, respectively. The motors 23, 24 are driven by power feeding from an in-vehicle battery, not shown. The motors 23, 24 may have reduction gears.

One of the pair of drive wheels 21, 22 and the pair of driven wheels 31, 32 is provide on the front of the vehicle 10 in the traveling direction, and the other of them is provide on the rear of the vehicle 10 in the traveling direction. In the present embodiment, the pair of driven wheels 31, 32 is provide on the front of the vehicle 10 in the traveling direction, and the pair of drive wheels 21, 22 is provide on the rear of the vehicle 10 in the traveling direction.

In the vehicle 10, the positions of the drive wheels 21, 22 and the positions of the driven wheels 31, 32 can be changed. Changing the positions of the wheels can adjust a tread, which is a distance between the drive wheels 21 and 22. Specifically, the vehicle body 11 has a plurality of mounted portions for each of the right and left drive wheels 21, 22 and the right and left driven wheels 31, 32. Changing mounting positions of the wheels at the vehicle body 11 can adjust the tread. The vehicle body 11 may have a configuration in which the mounting positions of the wheels can be changed by a slide or the like in a state in which the wheels are mounted. It is noted that only the positions of the drive wheels 21, 22 may be capable of being changed.

The vehicle 10 can move forward, move backward, and turn by the drive wheels 21, 22 independently driven. The vehicle 10 moves forward by positive rotation of the drive wheels 21, 22 and moves backward by negative rotation of the drive wheels 21, 22. In addition, differentiating rotational speeds of the right and left drive wheels 21, 22 from each other turns the vehicle 10.

The vehicle body 11 has a loading part, not shown, on which goods are loaded. It is desirable that the loading part can load and unload goods using robotic arms or the like in an automated warehouse.

The vehicle 10 includes a control device 40 having a microcomputer, various memories, and the like, a sensor 50 that detects a state of the vehicle 10, and a communication device 60 that can perform radio communication with an external device 100. The control device 40 executes various programs stored in the memory. The sensor 50 includes, for example, an acceleration sensor that detects an acceleration in the longitudinal direction (traveling direction) of the vehicle 10, and a yaw rate sensor that detects a yaw rate, which is a lateral acceleration in the horizontal direction of the vehicle 10. The acceleration sensor can detect an acceleration when the vehicle 10 travels straight ahead. In addition, the yaw rate sensor can detect a yaw rate (lateral acceleration) when the vehicle 10 turns. In addition, the inverters 25, 26 are provided with current sensors that respectively detect motor currents flowing through coils of the motors 23, 24.

The control device 40 controls drive of the motors 23, 24 of the respective drive wheels 21, 22 based on a traveling command value transmitted from the external device 100 and received by the communication device 60. Specifically, when the vehicle travels, the control device 40 receives a speed command value, a yaw rate command value (turning command value), and an acceleration command value of the vehicle 10 via the communication device 60 and calculates target rotational speeds of the motors 23, 24 of the respective right and left drive wheels 21, 22 based on the command values, the tread of the vehicle 10, and wheel diameters of the drive wheels 21, 22. Then, the control device 40 performs rotational speed feedback control by controlling the inverters 25, 26 so that the rotational speeds of the motors 23, 24 reach the target rotational speeds.

In the vehicle 10 that conveys goods in an automated warehouse, when presence or absence of loaded goods is changed or the loaded goods are changed, it can be considered that the position P of the center of gravity of the vehicle 10 is changed, which affects the vehicle traveling state. Particularly, if the ratio of weight of a load to weight of a vehicle body is high, influence of the change of the position P of the center of gravity becomes significant.

Hence, in the present embodiment, the position P of the center of gravity at the time when the vehicle 10 conveys goods is calculated and rotational speeds or moving velocities of the drive wheels 21, 22 are controlled based on the position P of the center of gravity. In addition, in the present embodiment, as various parameters indicating states of the vehicle 10, other than the position P of the center of gravity of the vehicle 10, weight m of the vehicle 10, inertia Iz, which is rotary inertia of the vehicle 10, and a tread b of the vehicle 10 are calculated, and these parameters are used for travel control of the vehicle 10.

As illustrated in FIG. 2, in the vehicle 10, the longitudinal direction, the horizontal direction, and the vertical direction are respectively set as the x direction, the y direction, and the z direction. In addition, an x-y coordinate position of the origin O, which is the center position between the drive wheels 21, 22 is set to (0, 0), and an x-y coordinate position of the position P of the center of gravity of the vehicle 10 is set to (Px, Py). In addition, the distance between the centers of contact areas of the right and left drive wheels 21, 22 is set as a tread b.

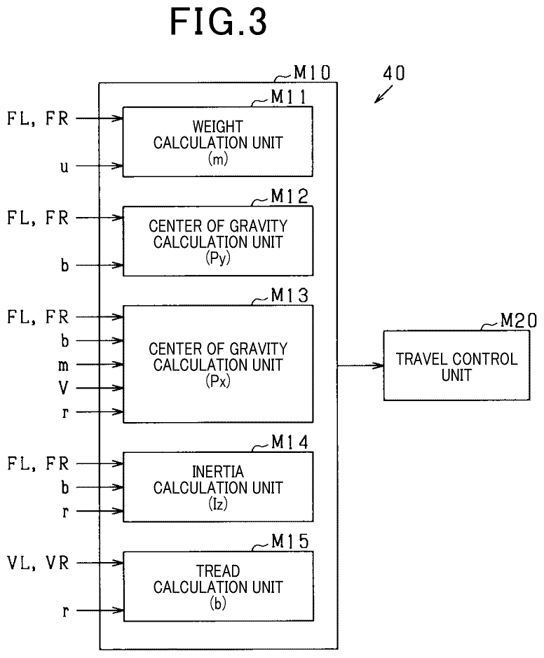

FIG. 3 is a block diagram illustrating an overview of functions performed by the control device 40. The functions illustrated in FIG. 3 can be implemented by an arithmetic program executed by the control 5 device 40.

As illustrated in FIG. 3, the control device 40 has a parameter calculation unit M10 that calculates various parameters of the vehicle and a travel control unit M20 that controls travel of the vehicle 10 based on the various parameters calculated by the parameter 10) calculation unit M10. In addition, the parameter calculation unit M10 has a weight calculation unit M11 that calculates the weight m [kg] of the vehicle 10, a center of gravity calculation unit M12 that calculates the position Py of the center of gravity in the horizontal direction of the vehicle 10, a center of gravity calculation unit M13 that calculates the position Px of the center of gravity in the longitudinal direction of the vehicle 10, and an inertia calculation unit M14 that calculate inertia Iz [kg·mg], which is rotary inertia of the vehicle 10. The tread b of the vehicle 10 may be a known value. However, in a case of the vehicle 10 in which the tread is changeable, the control device 40 may further have a tread calculation unit M15 that calculates the tread b [m]. When the vehicle travels, these calculation units calculate the parameters under a state in which command values of a vehicle speed V [m/s] and a yaw rate r [rad/s] are successively transmitted from the external device 100.

When the parameters are calculated, the control device 40 calculates thrusts FL, FR produced by rotation of the motors 23, 24 in the drive wheels 21, 22 and moving velocities VL, VR of the drive wheels 21, 22. Hereinafter, a procedure for calculating the thrusts FL, FR and the moving velocities VL, VR will be described.

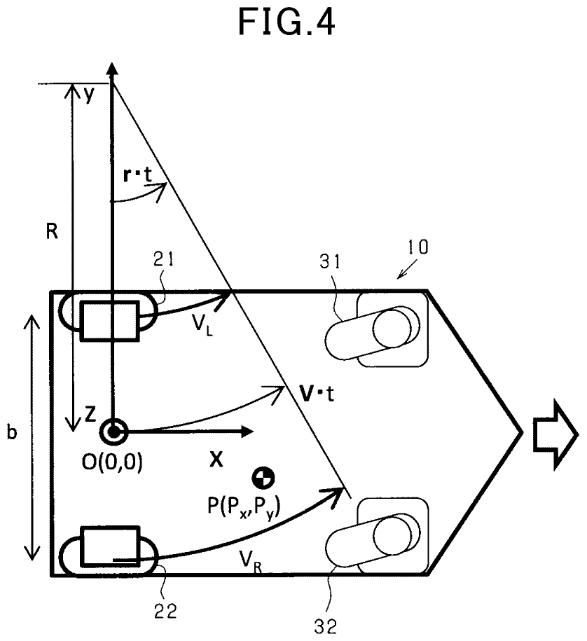

FIG. 4 is a diagram illustrating a state in which the drive wheels 21, 22 on the rear side are driven and the vehicle 10 turns based on the speed difference (rotational speed difference). Here, when the vehicle turns with a motion vector (V, r), a turning angle at t [sec] later is r·t [rad]. When a turning radius on the rear side of the vehicle is R [m], the following expression 1 is established.

$$r \cdot t = \frac{V \cdot t}{R} [ rad ] \\ r = \frac{V}{R} [ rad / s ] \\ \to V = r \cdot R [ m / s ] , R = \frac{V}{r} [ m ] \qquad [ Expression 1 ]$$

In addition, the moving velocities VL, VR of the drive wheels 21, 22 can be calculated from the vehicle speed V, the yaw rate r, and the tread b using the following expression 2.

$${V}_{R} = r \cdot ( R + \frac{b}{2} ) = r \cdot ( \frac{V}{r} + \frac{b}{2} ) = V + \frac{r \cdot b}{2} [ m / s ] \\ {V}_{L} = r \cdot ( R - \frac{b}{2} ) = r \cdot ( \frac{V}{r} - \frac{b}{2} ) = V - \frac{r \cdot b}{2} [ m / s ] \qquad [ Expression 2 ]$$

In addition, when the vehicle 10 travels by drive of the motors 23, 24, the control device 40 calculates motor torque from motor currents detected by the inverters 25, 26 and converts the motor torque by the wheel diameters to calculate the thrusts FR, FL of the drive wheels 21, 22. It is noted that the configuration in which rotational speeds of the motors 23, 24 can be detected can calculate the moving velocities VL, VR of the drive wheels 21, 22 from the rotational speeds of the motors and the wheel diameters.

Next, parameter calculation by the weight calculation unit M11, the center of gravity calculation units M12, M13, the inertia calculation unit M14, and the tread calculation unit M15 of the parameter calculation unit M10 will be described specifically.

### <Weight Calculation Unit M11>

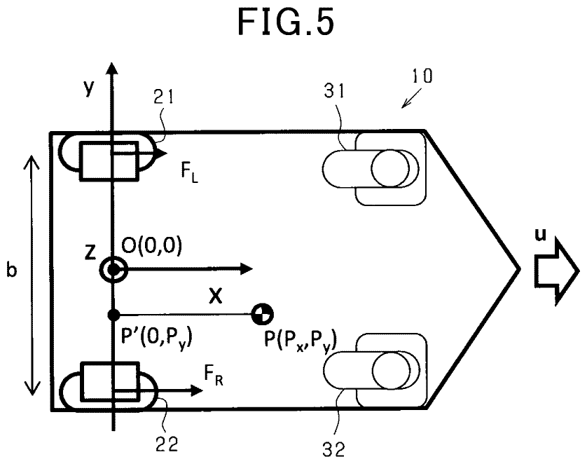

FIG. 5 is a diagram illustrating an overview of calculation of the weight m and the position Py of the center of gravity in the horizontal direction. FIG. 5 illustrates a state in which the vehicle 10 accelerates straight ahead at an acceleration u [m/s2].

The weight calculation unit M11 uses the following expression 3 to calculate the weight m of the vehicle 10 from the thrusts FL, FR of the drive wheels 21, 22 and the acceleration u in the traveling direction of the vehicle. It is noted that the acceleration u in the traveling direction of the vehicle may be a value detected by the acceleration sensor.

$$m \cdot u = {F}_{R} + {F}_{L} \\ m = \frac{{F}_{R} + {F}_{L}}{u} [ kg ] \qquad [ Expression 3 ]$$

### <Center of Gravity Calculation Unit M12>

In the traveling straight ahead state illustrated in FIG. 5, the vehicle 10 turns (does not travel straight ahead) if the moment around the center of gravity is not 0. Considering this, the center of gravity calculation unit M12 uses the following expression 4 to calculate the position Py of the center of gravity in the horizontal direction from the thrusts FL, FR of the drive wheels 21, 22 and the tread b.

$${F}_{R} \cdot ( \frac{b}{2} + {P}_{y} ) = {F}_{L} \cdot ( \frac{b}{2} - {P}_{y} ) \\ ( {F}_{R} + {F}_{L} ) \cdot {P}_{y} = \frac{b}{2} \cdot ( {F}_{L} - {F}_{P} ) \\ {P}_{y} = \frac{b}{2} \cdot \frac{{F}_{L} - {F}_{R}}{{F}_{R} + {F}_{L}} [ m ] \qquad [ Expression 4 ]$$

According to the center of gravity calculation unit M12, when the vehicle 10 travels straight ahead, the position Py of the center of gravity in the horizontal direction is calculated based on a thrust ratio that is a ratio between the sum of the thrusts FL, FR of the right and left drive wheels 21, 22 (FL+FR) and the difference between the thrusts FL and FR (FL−FR).

### <Center of Gravity Calculation Unit M13>

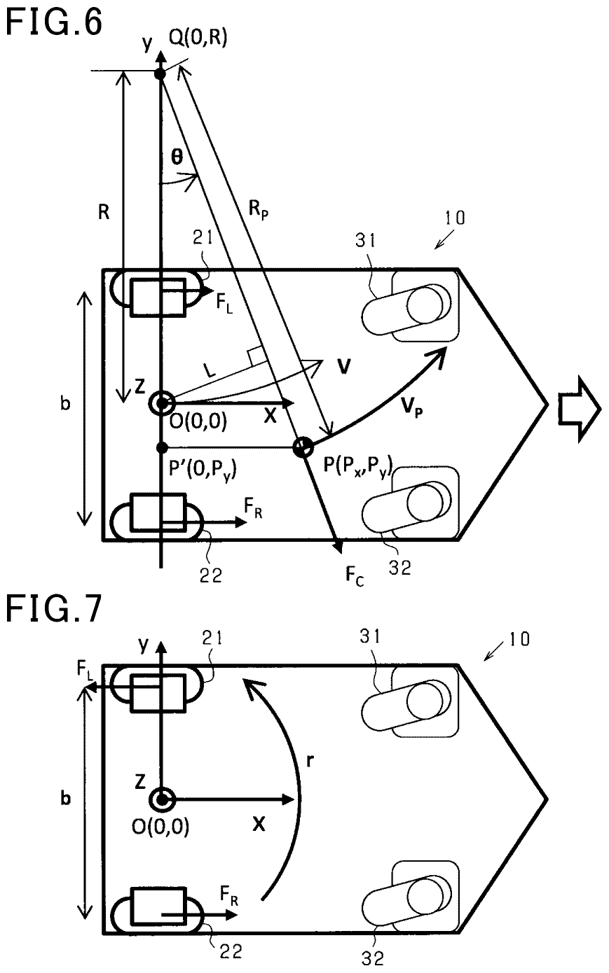

FIG. 6 is a diagram illustrating an overview of calculation of a position Px of the center of gravity in the longitudinal direction. FIG. 6 illustrates a state in which the vehicle 10 turns left with a motion vector (V, r). When the vehicle 10 turns with the motion vector (V, r), a centrifugal force Fc is generated on the straight line connecting a turning center point Q on the y-axis and the position P of the center of gravity of the vehicle 10. In this case, according to the next expression 5, the centrifugal force Fc of the vehicle 10 can be calculated from a velocity Vp [m/s] of the position P of the center of gravity, a turning radius Rp [m] of the position P of the center of gravity, and the weight m of the vehicle 10.

$${F}_{c} = \frac{m \cdot {V}_{P}^{2}}{{R}_{P}} [ N ] \qquad [ Expression 5 ]$$

In addition, when the vehicle 10 travels while turning, the moment produced by the thrusts FL, FR of the drive wheels 21, 22 coincides with the moment produced by the centrifugal force Fc, whereby the following expression 6 is established.

$${F}_{R} \cdot \frac{b}{2} - {F}_{L} \cdot \frac{b}{2} - {F}_{C} \cdot L = 0 \qquad [ Expression 6 ]$$

Considering this, the center of gravity calculation unit M13 calculates the position Px of the center of gravity in the longitudinal direction from the following expression 7. It is noted that the direction of left turning of the vehicle 10, that is, the counterclockwise direction in a planar view, is defined as a positive direction. In FIG. 6, L in expression 7 is the shortest distance from the origin O of the vehicle 10 to a straight line connecting the turning center point Q and the position P of the center of gravity of the vehicle 10.

$$sin θ = \frac{L}{R} \\ sin θ = \frac{PP ′}{{R}_{P}} = \frac{{P}_{x}}{\sqrt{{P}_{x}^{2} \cdot {( {R}_{f} - {P}_{y} )}^{2}}} \\ L = \frac{R \cdot {P}_{X}}{\sqrt{{P}_{x}^{2} + {( R - {P}_{y} )}^{2}}} \\ since r = \frac{{V}_{P}}{{R}_{P}} \\ {F}_{C} = \frac{m \cdot {V}_{P}^{2}}{{R}_{P}} = \frac{m \cdot {( r . {R}_{p} )}^{2}}{{R}_{P}} = \frac{m \cdot {r}^{2} \cdot {R}_{P}^{2}}{{R}_{P}} = m \cdot {r}^{2} \sqrt{{P}_{x}^{2} + {( R - {P}_{y} )}^{2}} \\ {F}_{C} \cdot L = m \cdot {r}^{2} \sqrt{{P}_{x}^{2} + {( R - {P}_{y} )}^{2}} \cdot \frac{R \cdot {P}_{X}}{\sqrt{{P}_{x}^{2} + {( R - {P}_{y} )}^{2}}} = m \cdot {r}^{2} \cdot R \cdot {P}_{x} \\ since r = \frac{V}{R} \\ {F}_{C} \cdot L = m \cdot r \cdot \frac{V}{R} \cdot R \cdot {P}_{x} = m \cdot r \cdot V \cdot {P}_{x} \\ since {F}_{R} \cdot \frac{b}{2} - {F}_{L} \cdot \frac{b}{2} - {F}_{C} \cdot L = 0 \\ {F}_{R} \cdot \frac{b}{2} - {F}_{L} \cdot \frac{b}{2} - m \cdot r \cdot V \cdot {P}_{x} = 0 \\ {P}_{x} = \frac{b}{2 \cdot m \cdot r \cdot V} ( {F}_{R} - {F}_{L} ) \qquad [ Expression 7 ]$$

According to the center of gravity calculation unit M13, when the vehicle 10 travels with turning, the position Px of the center of gravity in the longitudinal direction is calculated based on the magnitude of the difference obtained by subtracting the thrust of the drive wheel on the inside of turn from the thrust of the drive wheel on the outside of turn.

### <Inertia Calculation Unit M14>

FIG. 7 is a diagram illustrating an overview of calculation of the inertia Iz. The vehicle 10 can change direction by rotating the pair of drive wheels 21, 22 in the directions opposite to each other. FIG. 7 illustrates a state in which the motors 23, 24 in the right and left drive wheels 21, 22 are rotated in the directions opposite to each other to turn the vehicle 10 at that place.

The inertia calculation unit M14 uses the following expression 8 to calculate the inertia Iz in the turning direction (around the z-axis) from the sum of the thrusts FL, FR of the right and left drive wheels 21, 22 obtained when the drive wheels 21, 22 are rotated in the directions opposite to each other, a differential value of the yaw rate r detected by the yaw rate sensor, and the tread b.

$${I}_{Z} = \frac{dr}{dt} = {F}_{R} \cdot \frac{b}{2} + {F}_{L} \cdot \frac{b}{2} \\ {I}_{Z} = \frac{( {F}_{R} + {F}_{L} ) \cdot \frac{b}{2}}{\frac{dr}{dt}} [ kg \cdot {m}^{2} ] \qquad [ Expression 8 ]$$

### <Tread Calculation Unit M15>

The tread b is also calculated in the turning state illustrated in FIG. 4. The tread calculation unit M15 uses the following expression 9 to calculate the tread b from the moving velocities VL, VR of the drive wheels 21, 22 and the yaw rate r detected by the yaw rate sensor.

$$r = \frac{V}{R} = \frac{{V}_{R}}{R + \frac{b}{2}} = \frac{{V}_{L}}{R - \frac{b}{2}} [ rad / s ] \\ R + \frac{b}{2} = \frac{{V}_{R}}{r} [ m ] \\ R - \frac{b}{2} = \frac{{V}_{L}}{r} [ m ] \\ b = \frac{{V}_{R} - {V}_{L}}{r} [ m ] \qquad [ Expression 9 ]$$

### <Travel Control Unit M20>

When the vehicle 10 is caused to travel based on the vehicle speed V, the yaw rate r, and a traveling command value of the acceleration u, the travel control unit M20 predicts the thrusts FL, FR produced by motor rotation of the drive wheels 21, 22 based on the traveling command value, based on the traveling command value and the position Px, Py of the center of gravity of the vehicle 10. If the thrusts FL, FR exceed a predetermined limit value, the travel control unit M20 limits the rotational speeds or the moving velocities of the drive wheels 21, 22. In this case, while considering influence of the position Py of the center of gravity in the horizontal direction (y-axis direction) on the thrusts FL, FR and influence of the position Px of the center of gravity in the longitudinal direction (x-axis direction) on the thrusts FL, FR, the travel control unit M20 controls drive of the drive wheels 21, 22. Hereinafter, the details will be described.

When the vehicle 10 is caused to accelerate straight ahead by a command value of the acceleration u, considering influence of the position Py of the center of gravity in the y-axis direction on the thrusts FL, FR caused when the vehicle 10 accelerates straight ahead, the travel control unit M20 predicts, as a first thrust, the thrusts FL, FR produced by rotation of the motors 23, 24 of the drive wheels 21, 22 based on the command value of the acceleration u. Specifically, based on the following expression 10, the thrusts FL, FR (first thrust) are calculated.

$$\{ \begin{matrix}M \cdot u = {F}_{R} + {F}_{L} ⇒ {F}_{L} = m \cdot u - {F}_{R} \\ {F}_{R} \cdot ( \frac{b}{2} + {P}_{Y} ) = {F}_{L} \cdot ( \frac{b}{2} - {P}_{Y} ) ⇒ {F}_{R} = {F}_{L} \cdot \frac{\frac{b}{2} - {P}_{Y}}{\frac{b}{2} + {P}_{Y}}\end{matrix} \qquad [ Expression 10 ]$$

$${F}_{R} = {F}_{L} \cdot \frac{\frac{b}{2} - {P}_{Y}}{\frac{b}{2} + {P}_{Y}} \\ {F}_{L} \cdot \frac{\frac{b}{2} - {P}_{Y}}{\frac{b}{2} + {P}_{Y}} \\ = ( m \cdot u - {F}_{R} ) \cdot \frac{\frac{b}{2} - {P}_{Y}}{\frac{b}{2} + {P}_{Y}} \\ ( 1 - \frac{\frac{b}{2} - {P}_{Y}}{\frac{b}{2} + {P}_{Y}} ) \cdot {F}_{R} = m \cdot u \cdot \frac{\frac{b}{2} - {P}_{Y}}{\frac{b}{2} + {P}_{Y}} \\ {F}_{R} = \frac{m \cdot u \cdot \frac{\frac{b}{2} - {P}_{Y}}{\frac{b}{2} + {P}_{Y}}}{1 - \frac{\frac{b}{2} - {P}_{Y}}{\frac{b}{2} + {P}_{Y}}} = \frac{m \cdot u \cdot ( \frac{b}{2} - {P}_{Y} )}{b} \\ {F}_{L} = m \cdot u - {F}_{R} = m \cdot u - \frac{m \cdot u \cdot ( \frac{b}{2} - {P}_{Y} )}{b} = \frac{m \cdot u \cdot ( \frac{b}{2} + {P}_{Y} )}{b}$$

Then, if the thrusts FL, FR (first thrust) exceed the predetermined limit value, the travel control unit M20 limits the rotational speeds or the moving velocities of the drive wheels 21, 22.

In addition, when the vehicle 10 is caused to travel while turning by command values of the vehicle speed V and the yaw rate r, considering influence of the position Px of the center of gravity in the x-axis direction on the thrusts FL, FR caused when the vehicle 10 travels while turning, the travel control unit M20 predicts, as a second thrust, the thrusts FL, FR produced by rotation of the motors 23, 24 of the drive wheels 21, 22 based on the command values of the vehicle speed V and the yaw rate r. Specifically, based on the following expression 11, the thrusts FL, FR (second thrust) are calculated.

$$\{ \begin{matrix}( {F}_{R} + {F}_{L} ) \cdot \frac{b}{2} = {I}_{Z} \cdot \frac{dr}{dt} ⇒ {F}_{L} = \frac{{I}_{Z} \cdot \frac{dr}{dt}}{\frac{b}{2}} - {F}_{R} \\ PX = \frac{b}{2 \cdot m \cdot r \cdot V} ( FR - {F}_{L} ) ⇒ FR - {F}_{L} = \frac{m \cdot r \cdot V \cdot {P}_{X}}{\frac{b}{2}}\end{matrix} \qquad [ Expression 10 ]$$

$$FR - {F}_{L} = FR - ( \frac{{I}_{Z} \cdot \frac{dr}{dt}}{\frac{b}{2}} - {F}_{R} ) = \frac{m \cdot r \cdot V \cdot {P}_{X}}{\frac{b}{2}} \\ 2 \cdot {F}_{R} - \frac{{I}_{Z} \cdot \frac{dr}{dt}}{\frac{b}{2}} = \frac{m \cdot r \cdot V \cdot {P}_{X}}{\frac{b}{2}} \\ {F}_{R} = \frac{{I}_{Z} \cdot \frac{dr}{dt} + m \cdot r \cdot V \cdot {P}_{X}}{b} \\ {F}_{L} = \frac{{I}_{Z} \cdot \frac{dr}{dt}}{\frac{b}{2}} - {F}_{R} = \frac{{I}_{Z} \cdot \frac{dr}{dt}}{\frac{b}{2}} - \frac{{I}_{Z} \cdot \frac{dr}{dt} + m \cdot r \cdot V \cdot {P}_{X}}{b} = \frac{{I}_{Z} \cdot \frac{dr}{dt} - m \cdot r \cdot V \cdot {P}_{X}}{b}$$

Then, if the thrusts FL, FR (second thrust) exceeds the predetermined limit value, the travel control unit M20 limits the rotational speeds or the moving velocities of the drive wheels 21, 22.

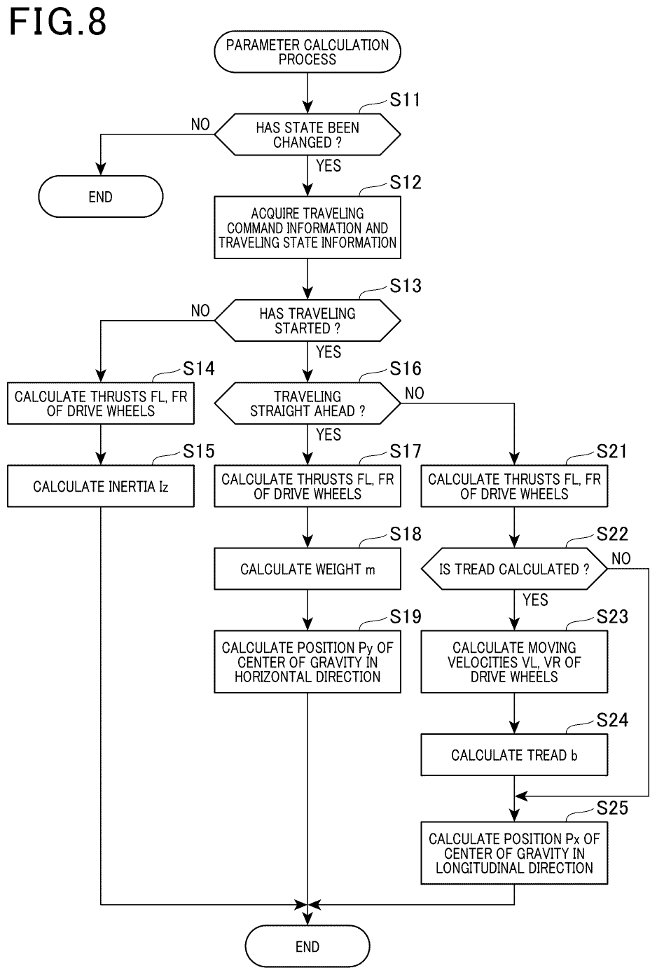

FIG. 8 is a flowchart of a procedure of calculating parameters. The present process is repeatedly performed by the control device 40 at predetermined intervals. In the present process, every time the vehicle travels, as parameters of the vehicle 10, the weight m of the vehicle 10, the position Px of the center of gravity in the horizontal direction (x direction), the position Py of the center of gravity in the longitudinal direction (y direction), the inertia Iz, which is rotary inertia, and the tread b are appropriately calculated.

In FIG. 8, in step S11, it is determined whether the state of the vehicle 10 has changed from the previous time when the vehicle travels. For example, in the vehicle 10, if presence or absence of loaded goods is changed or the loaded goods are changed, an affirmative determination is made in step S11. If the state of the vehicle 10 has been changed, the present process proceeds to succeeding step S12. If the state of the vehicle 10 has not been changed, the present process is completed.

In step S12, traveling command information and traveling state information of the vehicle 10 are acquired. Specifically, as the traveling command information, a command value of the vehicle speed V and a command value of the yaw rate r are acquired. In addition, as the traveling state information, detection information obtained from the acceleration sensor, the yaw rate sensor, and the like is acquired.

Then, in step S13, it is determined whether the vehicle 10 has started traveling. If the vehicle 10 has not started traveling, that is, the vehicle 10 is in a waiting state before the start of traveling, the present process proceeds to step S14. In step S14, the thrusts FL, FR of the right and left drive wheels 21, 22 are calculated in a state in which one of the drive wheels 21, 22 is caused to rotate in the positive direction and the other of the drive wheels 21, 22 is caused to rotate in the negative direction.

In step S15, the inertia Iz of the vehicle 10 is calculated based on the thrusts FL, FR calculated in step S14, the tread b, and the differential value of the yaw rate r (actual yaw rate) detected by the yaw rate sensor. Specifically, the inertia Iz is calculated using the expression 8 described above. It is noted that the tread b can be calculated in step S24 described later. Herein, a calculated value of the tread b before the present time or a specified value may be use as the tread b.

In contrast, if the vehicle 10 has started traveling, that is, the vehicle 10 is in a vehicle traveling state, the present process proceeds to step S16. In step S16, it is determined whether the vehicle 10 is currently traveling straight ahead. If the vehicle 10 is traveling straight ahead, the present process proceeds to step S17. If the vehicle 10 is not traveling straight ahead, that is, if the vehicle 10 is traveling while turning, the present process proceeds to step S21.

In step S17, the thrusts FL, FR of the right and left drive wheels 21, 22 in the traveling straight ahead state of the vehicle 10 are calculated. In step S18, the weight m of the vehicle 10 is calculated based on the thrusts FL, FR of the drive wheels 21, 22 and the acceleration u (actual acceleration) in the traveling direction of the vehicle detected by the acceleration sensor. Specifically, the weight m is calculated using the expression 3 described above.

Then, in step s19, the position Py of the center of gravity in the horizontal direction of the vehicle 10 is calculated based on the thrusts FL, FR of the drive wheels 21, 22 and the tread b. Specifically, the position Py of the center of gravity is calculated using the expression 4 described above.

In addition, when the vehicle 10 is traveling while turning, in step S21, the thrusts FL, FR of the right and left drive wheels 21, 22 are calculated in a state in which the vehicle 10 is traveling while turning. In step S22, it is determined whether the tread b of the vehicle 10 is calculated. At this time, if the vehicle 10 has a tread variable structure, and the tread b is changed before the current processing, an affirmative determination is made in step S22, and the present process proceeds to step S23. In step S23, the moving velocities VL, VR of the right and left drive wheels 21, 22 are calculated. Specifically, the moving velocities VL, VR are calculated using the expression 2 described above.

Then, in step S24, the tread b is calculated based on the moving velocities VL, VR of the drive wheels 21, 22 and the yaw rate r (actual yaw rate) detected by the yaw rate sensor. Specifically, the tread b is calculated using the expression 9 described above. It is noted that if the calculation of the tread b is not required, steps S23, S24 are skipped.

In step S25, the position Px of the center of gravity in the longitudinal direction of the vehicle 10 is calculated based on the command values of the vehicle speed V and the yaw rate r, the thrusts FL, FR of the drive wheels 21, 22, the tread b, and the weight m. Specifically, the position Px of the center of gravity is calculated using the expression 7 described above.

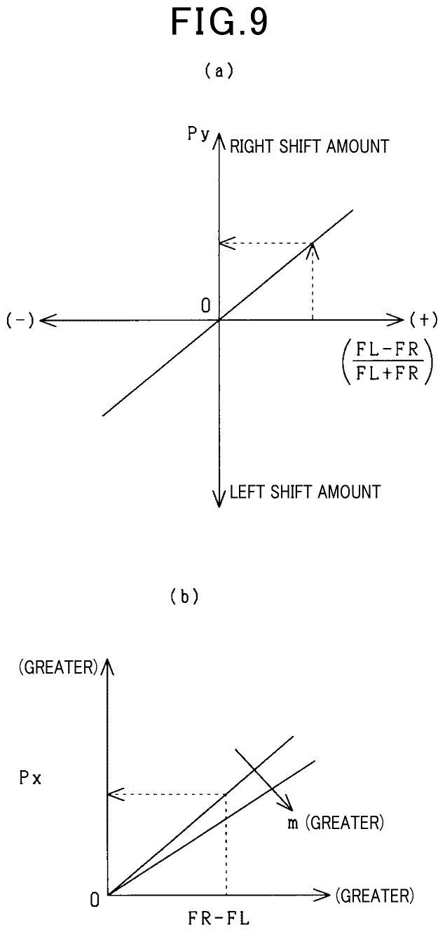

It is noted that, in step S19, the position Py of the center of gravity in the horizontal direction of the vehicle 10 can be calculated using a relationship illustrated in FIG. 9(a). FIG. 9(a) illustrates the relationship between a thrust ratio that is indicated by the horizontal axis and is a ratio between the sum of the thrusts of the right and left drive wheels 21, 22 (FL+FR) and the difference of the thrusts (FL−FR), and the position Py of the center of gravity in the horizontal direction (specifically, the y coordinate position of the position P of the center of gravity) that is indicated by the vertical axis. According to FIG. 9(a), as the thrust ratio increases to the positive side, the calculated position Py of the center of gravity is shifted toward the right. As the thrust ratio increases to the negative side, the calculated position Py of the 15 center of gravity is shifted toward the left.

In addition, in step S25, the position Px of the center of gravity in the longitudinal direction of the vehicle 10 can also be calculated using a relationship illustrated in FIG. 9(b). FIG. 9(b) illustrates the relationship between a difference (FR−FL) that is indicated by the vertical axis and is obtained by subtracting the thrust of the drive wheel on the inside of turn from the thrust of the drive wheel on the outside of turn, and the position Px of the center of gravity in the longitudinal direction (specifically, the x coordinate position of the position P of the center of gravity) that is indicated by the vertical axis. According to FIG. 9(b), as (FR−FL) increases, the calculated position Px of the center of gravity is shifted toward the front. In addition, FIG. 9(b) indicates that as the weight m of the vehicle 10 increases, the calculated position Px of the center of gravity is shifted toward the rear.

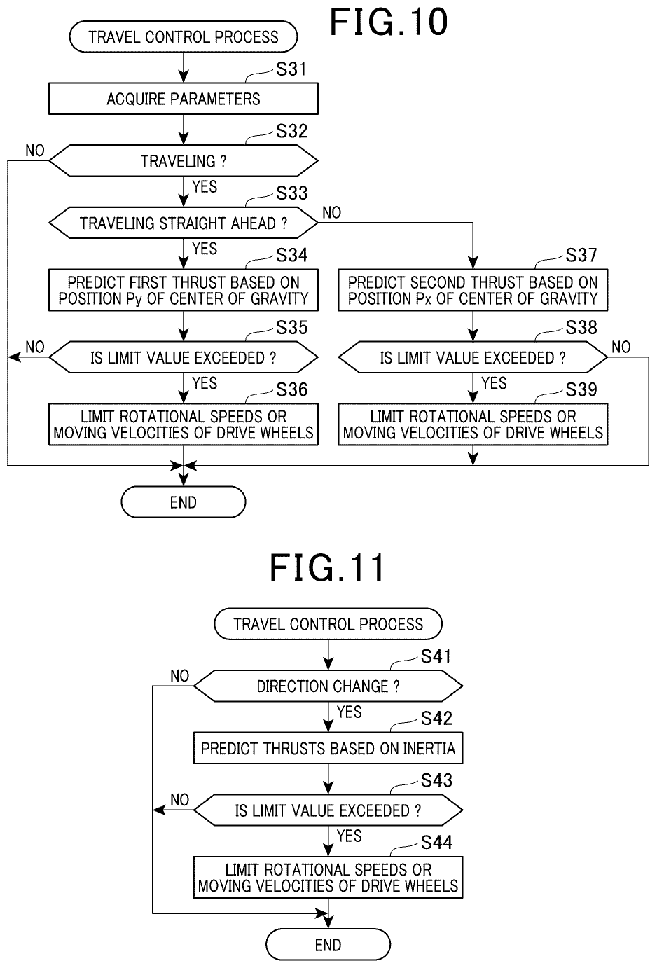

FIG. 10 is a flowchart of a procedure of travel control of the vehicle 10 performed using the parameters calculated by the parameter calculation process illustrated in FIG. 8. The present process is repeatedly performed by the control device 40 at predetermined intervals.

In FIG. 10, in step S31, parameters of the vehicle 10 are acquired. Specifically, the position of the center Px, Py of gravity, the weight m, the inertia Iz, and the tread b are acquired.

In step S32, it is determined whether the vehicle 10 is currently traveling. If the vehicle 10 is traveling, the present process proceeds to step S34. In step S33, it is determined whether the vehicle 10 is in a traveling straight ahead state. If the vehicle 10 is in a traveling straight ahead state, the present process proceeds to step S34. If the vehicle 10 is not in a traveling straight ahead state but is traveling while turning, the present process proceeds to step S37.

In step S34, as a first thrust, the thrusts FL, FR produced by rotation of the motors 23, 24 of the drive wheels 21, 22 are predicted based on the command value of the acceleration u at the time when the vehicle 10 is accelerated straight ahead, the position Py of the center of gravity in the horizontal direction of the vehicle 10, the weight m, and the tread b. Specifically, the thrusts FL, FR (first thrust) are calculated using the expression 10 described above.

Then, in step S35, it is determined whether the thrusts FL, FR (first thrust) calculated in step S34 have exceeded a limit value that can be implemented by the motors 23, 24 of the drive wheels 21, 22. If predicted values of the thrusts FL, FR have exceeded the limit value, the process proceeds to step S36, in which rotational speeds or moving velocities of the drive wheels 21, 22 are limited. Specifically, for example, in order to lower the rotational speeds or the moving velocities of the drive wheels 21, 22, target rotational speeds of the drive wheels 21, 22 are decreased.

In addition, in step S37, the thrusts FL, FR produced by rotation of the motors 23, 24 of the drive wheels 21, 22 are predicted as a second thrust based on the command values of the vehicle speed V and the yaw rate r at the time when the vehicle 10 is caused to travel while turning, the position Px of the center of gravity in the longitudinal direction of the vehicle 10, the weight m, the tread b, and the inertia Iz. Specifically, the thrusts FL, FR (second thrust) are calculated using the expression 11 described above.

Then, in step S38, it is determined whether the thrusts FL, FR (second thrust) calculated in step S37 have exceeded a limit value that can be implemented by the motors 23, 24 of the drive wheels 21, 22. If predicted values of the thrusts FL, FR have exceeded the limit value, the process proceeds to step S38, in which rotational speeds or moving velocities of the drive wheels 21, 22 are limited. Specifically, for example, in order to lower the rotational speeds or the moving velocities of the drive wheels 21, 22, target rotational speeds of the drive wheels 21, 22 are decreased.

According to the present embodiment described above, the following advantageous effects can be obtained.

When the vehicle 10 travels on a predetermined path, it can be considered that thrusts (or torque) of the drive wheels 21, 22 vary depending on the relationship between a position of the pair of the drive wheels 21, 22 and the position P of the center of gravity. In view of this point, the rotational speeds or the moving velocities of the drive wheels 21, 22 are controlled based on the position P of the center of gravity calculated from the thrusts FL, FR of the drive wheels 21, 22 when the vehicle travels. Hence, even when the position P of the center of gravity of the vehicle 10 is changed due to the state of loading of goods or the like, the vehicle can travel depending on the change of the position P of the center of gravity. As a result, in the vehicle 10 including the independently driven pair of drive wheels 21, 22 and the steerable driven wheels 31, 32, the position P of the center of gravity of the vehicle 10 can be suitably calculated, whereby the vehicle 10 can be caused to appropriately travel.

When the vehicle 10 travels straight ahead, if the position Py of the center of gravity in the horizontal direction of the vehicle 10 is displaced from the center position between the pair of drive wheels 21, 22, a difference is generated between the thrusts FL and FR produced in the right and left drive wheels 21, 22. In view of this point, when the vehicle 10 travels straight ahead, the position Py of the center of gravity in the horizontal direction of the vehicle 10 is calculated based on the thrust ratio between the sum of the thrusts FL, FR of the right and left drive wheels 21, 22 and the difference between the thrusts FL and FR. In addition, when the vehicle 10 travels while turning, depending on whether the position Px of the center of gravity in the longitudinal direction of the vehicle 10 is shifted toward the front or the rear, the turning radius of the vehicle 10 is affected. As a result, the difference between the thrusts FL and FR varies in the drive wheels 21, 22 on the outside of turn and the inside of turn. In view of this point, when the vehicle 10 travels while turning, the position Px of the center of gravity in the longitudinal direction of the vehicle 10 is calculated based on the magnitude of the difference obtained by subtracting the thrust of the drive wheel on the inside of turn from the thrust of the drive wheel on the outside of turn. According to the above configuration, the position Py of the center of gravity in the horizontal direction of the vehicle 10 and the position Px of the center of gravity in the longitudinal direction of the vehicle 10 can be suitably calculated.

When the vehicle 10 travels at a vehicle speed V and a yaw rate r, the thrusts FL, FR of the drive wheels 21, 22 under the traveling state at the vehicle speed V and the yaw rate r depend on weight m of the vehicle 10, the tread b, and the position Px, Py of the center of gravity. That is, these parameters have a predetermined correlation. In view of this point, when the vehicle 10 travels straight ahead, and when the vehicle 10 travels while turning, vehicle traveling information such as the speed V, the yaw rate r, the weight m, and the tread b of the vehicle 10 is used to calculate the position Px, Py of the center of gravity of the vehicle 10. Hence, travel control of the vehicle 10 can be performed even more appropriately.

When the vehicle 10 travels straight ahead, the weight m of the vehicle 10 is calculated based on the thrusts FL, FR of the drive wheels 21, 22 and an acceleration in the longitudinal direction detected by the acceleration sensor. Hence, even a vehicle in which no weight sensor is installed can estimate the weight of the vehicle. Therefore, regardless of presence or absence of a weight sensor, the weight m of the vehicle 10 can be appropriately determined, and furthermore, the position P of the center of gravity of the vehicle 10 can be appropriately acquired.

When the vehicle 10 travels while turning, the moving velocities VL, VR of the right and left drive wheels 21, 22 are calculated, and the tread b of the vehicle 10 is calculated based on a yaw rate detected by the yaw rate sensor. Hence, even after the tread b is changed in the vehicle 10, the tread b can be appropriately determined, and furthermore, the position P of the center of gravity of the vehicle 10 can be appropriately acquired.

Under a state in which the position Px, Py of the center of gravity of the vehicle 10 is changed, there is a concern that the thrusts FL, FR of the drive wheels 21, 22 may reach a limit value depending on a request for travel of the vehicle 10, whereby the vehicle becomes difficult to appropriately travel. Hence, when the vehicle 10 is caused to travel by a traveling command value, the thrusts FL, FR produced by motor rotation of the drive wheels 21, 22 based on the traveling command value are predicted based on the traveling command value and the position Px, Py of the center of gravity of the vehicle 10. If the predicted thrusts FL, FR exceed a predetermined limit value, the rotational speeds or the moving velocities of the drive wheels 21, 22 are limited. Thus, even if the request for travel is changed at the time when the vehicle travels while turning, the vehicle 10 can travel appropriately depending on the position Px, Py of the center of gravity of the vehicle 10.

When the vehicle 10 accelerates straight ahead, the position Py of the center of gravity in the horizontal direction of the vehicle 10 affects the thrusts FL, FR of the drive wheels 21, 22. Considering this, when the vehicle 10 is caused to travel straight ahead by a traveling command value, as a first thrust, the thrusts FL, FR produced by motor rotation of the drive wheels 21, 22 based on the traveling command value are predicted based on the traveling command value and the position Py of the center of gravity in the horizontal direction. If the first thrust exceeds the predetermined limit value, the rotational speeds or the moving velocities of the drive wheels 21, 22 are limited. Thus, even when the position P of the center of gravity of the vehicle 10 is displaced to the right or the left, the vehicle 10 can travel straight ahead appropriately.

In addition, when the vehicle 10 travels while turning, the position Px of the center of gravity in the longitudinal direction of the vehicle 10 affects the thrusts FL, FR of the drive wheels 21, 22. Considering this, when the vehicle 10 is caused to travel while turning by a traveling command value, as a second thrust, the thrusts FL, FR produced by motor rotation of the drive wheels 21, 22 based on the traveling command value are predicted based on the traveling command value and the position Px of the center of gravity in the longitudinal direction. If the second thrust exceeds the predetermined limit value, the rotational speeds or the moving velocities of the drive wheels 21, 22 are limited. Thus, even when the position P of the center of gravity of the vehicle 10 is displaced to the front or the rear, the vehicle 10 can travel appropriately while turning.

In a state in which the drive wheels 21, 22 are rotated in the directions opposite to each other, the thrusts FL, FR produced by motor rotation of the drive wheels 21, 22 are calculated, and the inertia Iz of the vehicle 10 is calculated based on the sum of the thrusts FL, FR and the differential value of the yaw rate detected by the yaw rate sensor. Hence, even when the inertia Iz varies depending on the state of loading of goods or the like of the vehicle 10, the inertia Iz can be appropriately calculated.

In addition, when the vehicle 10 is caused to travel while turning by the traveling command value, the thrusts FL, FR (second thrust) at the time when the vehicle travels while turning are predicted based on the traveling command value, the position Px of the center of gravity in the longitudinal direction, and the inertia Iz. Here, when the inertia Iz varies depending on the state of loading of goods or the like of the vehicle 10, there is a concern that the thrusts FL, FR of the drive wheels 21, 22 required when the vehicle travels while turning may vary, and the thrusts FL, FR exceed the limit value. However, according to the above configuration, the thrusts FL, FR (second thrust) of the drive wheels 21, 22 can be appropriately predicted with the inertia Iz being considered, and furthermore, the vehicle can travel appropriately.

### OTHER EMBODIMENTS

The above embodiment may be modified as below.

When the vehicle 10 turns at that place without moving (when the vehicle 10 changes direction), the thrusts FR, FL of the drive wheels 21, 22 are predicted. If the predicted value exceeds a predetermined limit value, the rotational speeds or the moving velocities of the drive wheels 21, 22 can be limited. In this case, the following expression 12 may be used to predict the thrusts FL, FR of the drive wheels 21, 22 with influence of the inertia Iz on the thrusts FL, FR being considered. It is noted that the inertia Iz may be calculated by the inertia calculation unit M14 illustrated in FIG. 3 as described above.

$${I}_{Z} = \frac{( {F}_{R} + {F}_{L} ) \cdot \frac{b}{2}}{\frac{dr}{dt}} \qquad [ Expression 12 ]$$

when turning at that place, F_{R}=F_{L}

$${I}_{Z} = \frac{2 {F}_{R} \cdot \frac{b}{2}}{\frac{dr}{dt}} \\ {F}_{R} = \frac{{I}_{Z} \cdot \frac{dr}{dt}}{b} = {F}_{L}$$

FIG. 11 is a flowchart of a procedure of travel control performed when the vehicle 10 changes direction. The present process is repeatedly performed by the control device 40 at predetermined intervals. It is noted that the travel control process illustrated in FIG. 11 may be performed in parallel with the travel control process illustrated in FIG. 10 described above.

In FIG. 11, in step S41, it is determined whether the vehicle 10 is currently caused to change direction without moving. If the vehicle 10 is caused to change direction, the present process proceeds to step S42. In step S42, the thrusts FL, FR produced by rotation of the motors 23, 24 of the drive wheels 21, 22 are predicted based on a differential value of the yaw rate command value, the inertia Iz, and the tread b obtained when the vehicle 10 is caused to change direction. Specifically, the thrusts FL, FR are calculated using the expression 12 described above.

Then, in step S43, it is determined whether the thrusts FL, FR calculated in step S34 have exceeded a limit value that can be implemented by the motors 23, 24 of the drive wheels 21, 22. If predicted values of the thrusts FL, FR have exceeded the limit value, the process proceeds to step S44, in which rotational speeds or moving velocities of the drive wheels 21, 22 are limited. Specifically, for example, in order to lower the rotational speeds or the moving velocities of the drive wheels 21, 22, target rotational speeds of the drive wheels 21, 22 are decreased.

According to the above configuration, even when the inertia Iz (rotary inertia) varies depending on the state of loading of goods or the like of the vehicle 10, the vehicle 10 can travel appropriately depending on the inertia Iz.

According to the above embodiment, when the vehicle 10 travels straight ahead, the weight m of the vehicle 10 is calculated based on the thrusts FL, FR of the drive wheels 21, 22 and an acceleration (actual acceleration) detected by the acceleration sensor. However, a weight sensor, which acquires information of the weight m, may be provided to the vehicle 10.

According to the above embodiment, while rotation of the drive wheels 21, 22 is limited based on the first thrust predicted based on the position Py of the center of gravity in the horizontal direction when the vehicle 10 travels straight ahead, rotation of the drive wheels 21, 22 is limited based on the second thrust predicted based on the position Px of the center of gravity in the longitudinal direction when the vehicle 10 travels while turning. However, this may be modified. For example, rotation of the drive wheels 21, 22 may be limited either when the vehicle 10 travels straight ahead or when the vehicle 10 travels while turning.

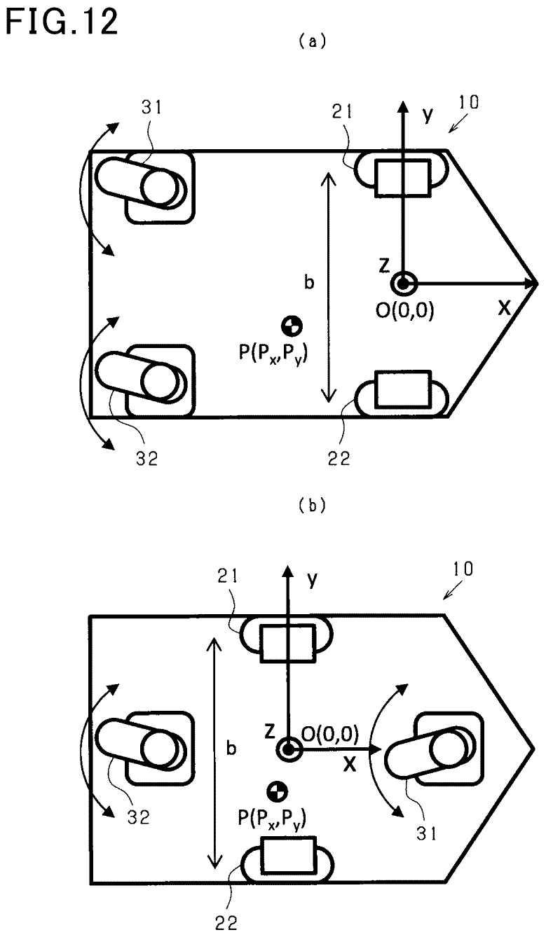

The vehicle 10 may have a configuration illustrated in FIG. 12 (a) or (b). The vehicle 10 in FIG. 12(a) is provided with the pair of drive wheels 21, 22 on the front of the vehicle 10 in the traveling direction and the pair of driven wheels 31, 32 on the rear of the vehicle 10 in the traveling direction. In addition, the vehicle 10 in FIG. 12 (b) is provided with the pair of right and left drive wheels 21, 22 at the substantially central position in the longitudinal direction of the vehicle and the respective driven wheels 31, 32 at the front end and the rear end of the vehicle 10 and the central position in the horizontal direction. Also in the case of the vehicle 10 having such configurations, similarly to the above, when the vehicle 10 travels, the position P of the center of gravity of the vehicle 10 may be calculated, and rotational speeds or moving velocities of the drive wheels 21, 22 may be controlled based on the position P of the center of gravity.

When the vehicle 10 convey no goods but performs simulated travel, parameters of the vehicle 10 may be calculated.

In the above embodiment, the functions illustrated in FIG. 3 are performed by the in-vehicle control device 40. However, this may be modified so that the functions illustrated in FIG. 3 may be performed by the external device 100.

The control unit and the processing thereof described in the present disclosure may be implemented by a dedicated computer which is provided by configuring a processor and a memory that are programmed to execute one or more functions embodied by a computer program. Alternatively, the control unit and the processing thereof described in the present disclosure may be implemented by a dedicated computer which is provided by configuring a processor with one or more dedicated hardware logic circuits. Alternatively, the control unit and the processing thereof described in the present disclosure may be implemented by one or more dedicated computers which are configured by combining a processor and a memory that are programmed to execute one or more functions, with a processor that is configured by one or more hardware logic circuits. Furthermore, the computer program may be stored in a computer readable non-transitory tangible storage medium, as instructions to be executed by a computer.

The present disclosure has so far been described based on embodiments. However, the present disclosure should not be construed as being limited to these embodiments or the structures. The present disclosure should encompass various modifications, and modifications within the range of equivalence. In addition, various combinations and modes, as well as other combinations and modes, including those which include one or more additional elements, or those which include fewer elements should be construed as being within the scope and spirit of the present disclosure.

Hereinafter, characteristic configurations extracted from the above embodiments will be described.

### [Configuration 1]

A vehicle control device (40, 100) that is applied to a vehicle (10) including: a vehicle body (11); a pair of drive wheels (21, 22) that are mounted to the vehicle body at two positions, which are right and left positions with respect to a traveling direction, and respectively have motors (23, 24) that are independently driven; and steerable driven wheels (31, 32) mounted to the vehicle body, the vehicle control device controlling controls drive of the motors of the drive wheels to control travel of the vehicle,
the vehicle control device (40, 100) including:
a thrust calculation unit that calculates a thrust produced by rotation of the motors at the drive wheels when the vehicle travels on a predetermined path;
a center of gravity calculation unit that calculates a position of a center of gravity of the vehicle in a coordinate system whose origin is a center position between the pair of drive wheels, based on the thrust calculated by the thrust calculation unit; and
a control unit that controls rotational speeds or moving velocities of the drive wheels based on the position of the center of gravity.

### [Configuration 2]

The vehicle control device according to configuration 1, wherein
when the vehicle travels straight ahead or when the vehicle travels while turning, the thrust calculation unit calculates the thrust produced by rotation of the motors at the drive wheels, and
the center of gravity calculation unit has:
a first calculation unit that calculates, when the vehicle travels straight ahead, a position of the center of gravity of the vehicle in a horizontal direction based on a thrust ratio between a sum of the thrusts of the right and left drive wheels and a difference between the thrusts; and
a second calculation unit that calculates, when the vehicle travels while turning, a position of the center of gravity of the vehicle in a longitudinal direction based on a magnitude of a difference obtained by subtracting the thrust of the drive wheel on the inside of turn from the thrust of the drive wheel on the outside of turn.

### [Configuration 3]

The vehicle control device according to configuration 2, further including an acquisition unit that acquires vehicle traveling information including a speed, a yaw rate, a weight, and a tread of the vehicle when the vehicle travels while turning, wherein
the first calculation unit calculates, when the vehicle travels straight ahead, the position of the center of gravity in the horizontal direction of the vehicle based on the thrust ratio and the vehicle traveling information acquired by the acquisition unit, and
the second calculation unit calculates, when the vehicle travels while turning, the position of the center of gravity of the vehicle in the longitudinal direction of the vehicle based on the vehicle traveling information acquired by the acquisition unit.

### [Configuration 4]

The vehicle control device according to configuration 3, wherein
the vehicle control device is applied to the vehicle including an acceleration sensor that detects an acceleration in the longitudinal direction of the vehicle, and further includes a weight calculation unit that calculates, when the vehicle travels straight ahead, weight of the vehicle based on the thrust calculated by the thrust calculation unit and the acceleration in the longitudinal direction detected by the acceleration sensor.

### [Configuration 5]

The vehicle control device according to configuration 3 or 4, wherein
the vehicle control device is applied to the vehicle including a yaw rate sensor that detects a yaw rate of the vehicle, and further includes:
a moving velocity calculation unit that calculates moving velocities of the right and left drive wheels when the vehicle travels while turning; and
a tread calculation unit that calculates a tread of the vehicle based on the moving velocities of the right and left drive wheels calculated by the moving velocity calculation unit and the yaw rate detected by the yaw rate sensor.

### [Configuration 6]

The vehicle control device according to any one of configurations 1 to 5, wherein
the vehicle is an autonomous travel vehicle that autonomously travels based on traveling command values that are respectively command values of a speed, an acceleration in a longitudinal direction, and a yaw rate of the vehicle,
the vehicle control device further includes a thrust prediction unit that predicts, when the vehicle is caused to travel based on the traveling command values, a thrust produced by rotation of the motors of the drive wheels based on the traveling command values, based on the position of the center of gravity of the vehicle calculated by the center of gravity calculation unit; and
if the thrust predicted by the thrust prediction unit exceeds a predetermined limit value, the control unit limits the rotational speeds or the moving velocities of the drive wheels.

### [Configuration 7]

The vehicle control device according to configuration 6, wherein
when the vehicle is caused to travel straight ahead by the traveling command values,
the thrust prediction unit predicts, as a first thrust, the thrust produced by rotation of the motors of the drive wheels based on the traveling command values, based on a position of the center of gravity of the vehicle in a horizontal direction, and
if the first thrust exceeds the predetermined limit value, the control unit limits the rotational speeds or the moving velocities of the drive wheels, and
when the vehicle is caused to travel while turning by the traveling command values,
the thrust prediction unit predicts, as a second thrust, the thrust produced by rotation of the motors of the drive wheels based on the traveling command values, based on a position of the center of gravity of the vehicle in a longitudinal direction, and
if the second thrust exceeds the predetermined limit value, the control unit limits the rotational speeds or the moving velocities of the drive wheel.

### [Configuration 8]

The vehicle control device according to configuration 7, wherein
the vehicle control device is applied to the vehicle including a yaw rate sensor that detects a yaw rate of the vehicle,
the thrust calculation unit calculates the thrust produced by rotation of the motors of the drive wheels in a state in which the pair of drive wheels are rotated in directions opposite to each other,
the vehicle control device further includes an inertia calculation unit that calculates a rotary inertia of the vehicle based on a sum of the thrusts of the drive wheels obtained when the pair of drive wheels are rotated in directions opposite to each other and a differential value of the yaw rate detected by the yaw rate sensor, and
when the vehicle is caused to travel while turning by the traveling command values, the thrust prediction unit predicts the second thrust based on the traveling command values, the position of the center of gravity of the vehicle in the longitudinal direction, and the rotary inertia calculated by the inertia calculation unit.

### [Configuration 9]

The vehicle control device according to any one of configurations 1 to 8, wherein
the vehicle control device is applied to the vehicle that includes a yaw rate sensor detecting a yaw rate of the vehicle and is capable of changing direction by rotating the pair of drive wheels in directions opposite to each other,
the thrust calculation unit calculates the thrust produced by rotation of the motors of the drive wheels in a state in which the pair of drive wheels are rotated in directions opposite to each other,
the vehicle control device further includes:
an inertia calculation unit that calculates a rotary inertia of the vehicle based on a sum of the thrusts of the drive wheels obtained when the pair of drive wheels are rotated in directions opposite to each other and a differential value of the yaw rate detected by the yaw rate sensor; and
a prediction unit that predicts, when the vehicle is caused to change direction based on a yaw rate command value, a thrust produced by rotation of the motors of the drive wheels based on the yaw rate command value, based on the yaw rate command value and the rotary inertia calculated by the inertia calculation unit, and
if the thrust predicted by the prediction unit exceeds a predetermined limit value, the control unit limits the rotational speeds or the moving velocities of the drive wheels.

A first aspect is a vehicle control device (40, 100) that is applied to a vehicle (10) including: a vehicle body (11); a pair of drive wheels (21, 22) that are mounted to the vehicle body at two positions, which are right and left positions with respect to a traveling direction, and respectively have motors (23, 24) that are independently driven; and steerable driven wheels (31, 32) mounted to the vehicle body, the vehicle control device controlling drive of the motors of the drive wheels to control travel of the vehicle,
the vehicle control device (40, 100) including:
a thrust calculation unit that calculates a thrust produced by rotation of the motors at the drive wheels when the vehicle travels on a predetermined path;
a center of gravity calculation unit that calculates a position of a center of gravity of the vehicle in a coordinate system whose origin is a center position between the pair of drive wheels, based on the thrust calculated by the thrust calculation unit; and
a control unit that controls rotational speeds or moving velocities of the drive wheels based on the position of the center of gravity.

In the vehicle including the independently driven pair of drive wheels and the steerable driven wheels, a thrust produced by rotation of the motors at the drive wheels is calculated when the vehicle travels on a predetermined path, a position of the center of gravity of the vehicle in a coordinate system whose origin is a center position between the pair of drive wheels is calculated based on the thrust, and rotational speeds or moving velocities of the drive wheels are controlled based on the position of the center of gravity. That is, when the vehicle travels on a predetermined path, it can be considered that thrusts (or torque) of the drive wheels vary depending on the relationship between a position of the pair of the drive wheels and the position of the center of gravity. In view of this point, the rotational speeds or the moving velocities of the drive wheels are controlled based on the position of the center of gravity calculated from the thrusts of the drive wheels when the vehicle travels. Hence, even when the position of the center of gravity of the vehicle is changed due to the state of loading of goods or the like, the vehicle can travel depending on the change of the position of the center of gravity. As a result, in the vehicle including the independently driven pair of drive wheels and the steerable driven wheels, the position of the center of gravity of the vehicle can be suitably calculated, whereby the vehicle can be caused to appropriately travel.

In a second aspect, when the vehicle travels straight ahead or when the vehicle travels while turning, the thrust calculation unit calculates the thrust produced by rotation of the motors at the drive wheels, and
the center of gravity calculation unit has:
a first calculation unit that calculates, when the vehicle travels straight ahead, a position of the center of gravity of the vehicle in a horizontal direction based on a thrust ratio between a sum of the thrusts of the right and left drive wheels and a difference between the thrusts; and
a second calculation unit that calculates, when the vehicle travels while turning, a position of the center of gravity of the vehicle in a longitudinal direction based on a magnitude of a difference obtained by subtracting the thrust of the drive wheel on the inside of turn from the thrust of the drive wheel on the outside of turn.

When the vehicle travels straight ahead, if the position (Py) of the center of gravity in the horizontal direction of the vehicle 10 is displaced from the center position between the pair of drive wheels, a difference is generated between the thrusts produced in the right and left drive wheels. In view of this point, when the vehicle travels straight ahead, the position (Py) of the center of gravity in the horizontal direction of the vehicle is calculated based on the thrust ratio between the sum of the thrusts of the right and left drive wheels and the difference between the thrusts FL and FR. In addition, when the vehicle travels while turning, depending on whether the position (Px) of the center of gravity in the longitudinal direction of the vehicle is shifted toward the front or the rear, the turning radius of the vehicle is affected. As a result, the difference between the thrusts varies in the drive wheels on the outside of turn and the inside of turn. In view of this point, when the vehicle travels while turning, the position (Px) of the center of gravity in the longitudinal direction of the vehicle is calculated based on the magnitude of the difference obtained by subtracting the thrust of the drive wheel on the inside of turn from the thrust of the drive wheel on the outside of turn. According to the above configuration, the position (Py) of the center of gravity in the horizontal direction of the vehicle and the position (Px) of the center of gravity in the longitudinal direction of the vehicle can be suitably calculated.

In a third aspect, an acquisition unit is included which acquires vehicle traveling information including a speed, a yaw rate, a weight, and a tread of the vehicle when the vehicle travels while turning. The first calculation unit calculates, when the vehicle travels straight ahead, the position of the center of gravity in the horizontal direction of the vehicle based on the thrust ratio and the vehicle traveling information acquired by the acquisition unit. The second calculation unit calculates, when the vehicle travels while turning, the position of the center of gravity of the vehicle in the longitudinal direction of the vehicle based on the vehicle traveling information acquired by the acquisition unit.

When the vehicle travels at a vehicle speed and a yaw rate, the thrusts of the drive wheels under the traveling state at the vehicle speed and the yaw rate depend on weight m of the vehicle, the tread, and the position (Px, Py) of the center of gravity. That is, these parameters have a predetermined correlation. In view of this point, when the vehicle travels straight ahead, and when the vehicle travels while turning, vehicle traveling information is used to calculate the position (Px, Py) of the center of gravity of the vehicle. Hence, travel control of the vehicle can be performed even more appropriately.

In a fourth aspect, the vehicle control device is applied to the vehicle including an acceleration sensor that detects an acceleration in the longitudinal direction of the vehicle, and further includes a weight calculation unit that calculates, when the vehicle travels straight ahead, weight of the vehicle based on the thrust calculated by the thrust calculation unit and the acceleration in the longitudinal direction detected by the acceleration sensor.

According to the above configuration, even a vehicle in which no weight sensor is installed can estimate the weight of the vehicle. Therefore, regardless of presence or absence of a weight sensor, the weight m of the vehicle can be appropriately determined, and furthermore, the position of the center of gravity of the vehicle can be appropriately acquired.

In a fifth aspect, the vehicle control device is applied to the vehicle including a yaw rate sensor that detects a yaw rate of the vehicle, and further includes: a moving velocity calculation unit that calculates moving velocities of the right and left drive wheels when the vehicle travels while turning; and a tread calculation unit that calculates a tread of the vehicle based on the moving velocities of the right and left drive wheels calculated by the moving velocity calculation unit and the yaw rate detected by the yaw rate sensor.

According to the above configuration, even after the tread is changed in the vehicle, the tread can be appropriately determined, and furthermore, the position of the center of gravity of the vehicle can be appropriately acquired.

In a sixth aspect, the vehicle is an autonomous travel vehicle that autonomously travels based on traveling command values that are respectively command values of a speed, an acceleration in a longitudinal direction, and a yaw rate of the vehicle. The vehicle control device further includes a thrust prediction unit that predicts, when the vehicle is caused to travel based on the traveling command values, a thrust produced by rotation of the motors of the drive wheels based on the traveling command values, based on the position of the center of gravity of the vehicle calculated by the center of gravity calculation unit. If the thrust predicted by the thrust prediction unit exceeds a predetermined limit value, the control unit limits the rotational speeds or the moving velocities of the drive wheels.

The autonomous travel vehicle that autonomously travels based on command values (traveling command values) of a vehicle speed, an acceleration in a longitudinal direction, and a yaw rate receives commands of the vehicle speed, the acceleration, and the yaw rate depending on the turning radius of the path or the like. Under a state in which the position of the center of gravity of the vehicle is changed, there is a concern that the thrusts of the drive wheels may reach a limit value depending on a request for travel of the vehicle, whereby the vehicle becomes difficult to appropriately travel. Hence, when the vehicle is caused to travel by a traveling command value, the thrusts produced by motor rotation of the drive wheels based on the traveling command value are predicted based on the traveling command value and the position of the center of gravity of the vehicle. If the predicted thrusts exceed a predetermined limit value, the rotational speeds or the moving velocities of the drive wheels are limited. Thus, even if the request for travel is changed at the time when the vehicle travels while turning, the vehicle can travel appropriately depending on the position of the center of gravity of the vehicle.

In a seventh aspect, when the vehicle is caused to travel straight ahead by the traveling command values,
the thrust prediction unit predicts, as a first thrust, the thrust produced by rotation of the motors of the drive wheels based on the traveling command values, based on a position of the center of gravity of the vehicle in a horizontal direction, and
if the first thrust exceeds the predetermined limit value, the control unit limits the rotational speeds or the moving velocities of the drive wheels, and
when the vehicle is caused to travel while turning by the traveling command values,
the thrust prediction unit predicts, as a second thrust, the thrust produced by rotation of the motors of the drive wheels based on the traveling command values, based on a position of the center of gravity of the vehicle in a longitudinal direction, and
if the second thrust exceeds the predetermined limit value, the control unit limits the rotational speeds or the moving velocities of the drive wheel.

When the vehicle accelerates straight ahead, the position (Py) of the center of gravity in the horizontal direction of the vehicle affects the thrusts of the drive wheels. Considering this, when the vehicle is caused to travel straight ahead by a traveling command value, as a first thrust, the thrusts produced by motor rotation of the drive wheels based on the traveling command value are predicted based on the traveling command value and the position (Py) of the center of gravity in the horizontal direction of the vehicle. If the first thrust exceeds the predetermined limit value, the rotational speeds or the moving velocities of the drive wheels are limited. Thus, even when the position of the center of gravity of the vehicle is displaced to the right or the left, the vehicle can travel straight ahead appropriately.

In addition, when the vehicle travels while turning, the position (Px) of the center of gravity in the longitudinal direction of the vehicle affects the thrusts of the drive wheels. Considering this, when the vehicle is caused to travel while turning by a traveling command value, as a second thrust, the thrusts produced by motor rotation of the drive wheels based on the traveling command value are predicted based on the traveling command value and the position (Px) of the center of gravity in the longitudinal direction. If the second thrust exceeds the predetermined limit value, the rotational speeds or the moving velocities of the drive wheels are limited. Thus, even when the position of the center of gravity of the vehicle is displaced to the front or the rear, the vehicle can travel while turning appropriately.

In an eighth aspect, the vehicle control device is applied to the vehicle including a yaw rate sensor that detects a yaw rate of the vehicle,
the thrust calculation unit calculates the thrust produced by rotation of the motors of the drive wheels in a state in which the pair of drive wheels are rotated in directions opposite to each other,
the vehicle control device further includes an inertia calculation unit that calculates a rotary inertia of the vehicle based on a sum of the thrusts of the drive wheels obtained when the pair of drive wheels are rotated in directions opposite to each other and a differential value of the yaw rate detected by the yaw rate sensor, and
when the vehicle is caused to travel while turning by the traveling command values, the thrust prediction unit predicts the second thrust based on the traveling command values, the position of the center of gravity of the vehicle in the longitudinal direction, and the rotary inertia calculated by the inertia calculation unit.

According to the above configuration, even when rotary inertia (inertia) varies depending on the state of loading of goods or the like of the vehicle, the rotary inertia can be appropriately calculated.

In addition, when the vehicle is caused to travel while turning by the traveling command value, the second thrust is predicted based on the traveling command value, the position of the center of gravity in the longitudinal direction of the vehicle, and the rotary inertia of the vehicle. Here, when the rotary inertia varies depending on the state of loading of goods or the like of the vehicle, there is a concern that the thrusts of the drive wheels required when the vehicle travels while turning may vary, and the thrusts exceed the limit value. However, according to the above configuration, the thrusts (second thrust) of the drive wheels can be appropriately predicted with the rotary inertia being considered, and furthermore, the vehicle can travel appropriately.

In a ninth aspect, the vehicle control device is applied to the vehicle that includes a yaw rate sensor detecting a yaw rate of the vehicle and is capable of changing direction by rotating the pair of drive wheels in directions opposite to each other,
the thrust calculation unit calculates the thrust produced by rotation of the motors of the drive wheels in a state in which the pair of drive wheels are rotated in directions opposite to each other,
the vehicle control device further includes:
an inertia calculation unit that calculates a rotary inertia of the vehicle based on a sum of the thrusts of the drive wheels obtained when the pair of drive wheels are rotated in directions opposite to each other and a differential value of the yaw rate detected by the yaw rate sensor; and
a prediction unit that predicts, when the vehicle is caused to change direction based on a yaw rate command value, a thrust produced by rotation of the motors of the drive wheels based on the yaw rate command value, based on the yaw rate command value and the rotary inertia calculated by the inertia calculation unit, and
if the thrust predicted by the prediction unit exceeds a predetermined limit value, the control unit limits the rotational speeds or the moving velocities of the drive wheels.

When the vehicle is caused to change direction based on a yaw rate command value, a thrust produced by rotation of the motors of the drive wheels is predicted based on the yaw rate command value, based on the yaw rate command value and the rotary inertia of the vehicle. If the thrust exceeds a predetermined limit value, the rotational speeds or the moving velocities of the drive wheels are limited. Hence, even when the rotary inertia varies depending on the state of loading of goods or the like of the vehicle, the vehicle can travel appropriately depending on the rotary inertia.

What is claimed is:

1. A vehicle control device that is applied to a vehicle including: a vehicle body; a pair of drive wheels that are mounted to the vehicle body at two positions, which are right and left positions with respect to a traveling direction, and respectively have motors that are independently driven; and steerable driven wheels mounted to the vehicle body, the vehicle control device controlling drive of the motors of the drive wheels to control travel of the vehicle,
the vehicle control device comprising:
a thrust calculation unit that calculates a thrust produced by rotation of the motors at the drive wheels when the vehicle travels on a predetermined path;
a center of gravity calculation unit that calculates a position of a center of gravity of the vehicle in a coordinate system whose origin is a center position between the pair of drive wheels, based on the thrust calculated by the thrust calculation unit; and
a control unit that controls rotational speeds or moving velocities of the drive wheels based on the position of the center of gravity.

2. The vehicle control device according to claim 1, wherein
when the vehicle travels straight ahead or when the vehicle travels while turning, the thrust calculation unit calculates the thrust produced by rotation of the motors at the drive wheels, and
the center of gravity calculation unit has:
a first calculation unit that calculates, when the vehicle travels straight ahead, a position of the center of gravity of the vehicle in a horizontal direction based on a thrust ratio between a sum of the thrusts of the right and left drive wheels and a difference between the thrusts; and
a second calculation unit that calculates, when the vehicle travels while turning, a position of the center of gravity of the vehicle in a longitudinal direction based on a magnitude of a difference obtained by subtracting the thrust of the drive wheel on the inside of turn from the thrust of the drive wheel on the outside of turn.

3. The vehicle control device according to claim 2, further comprising an acquisition unit that acquires vehicle traveling information including a speed, a yaw rate, a weight, and a tread of the vehicle when the vehicle travels while turning, wherein
the first calculation unit calculates, when the vehicle travels straight ahead, the position of the center of gravity in the horizontal direction of the vehicle based on the thrust ratio and the vehicle traveling information acquired by the acquisition unit, and
the second calculation unit calculates, when the vehicle travels while turning, the position of the center of gravity of the vehicle in the longitudinal direction of the vehicle based on the vehicle traveling information acquired by the acquisition unit.

4. The vehicle control device according to claim 3, wherein
the vehicle control device is applied to the vehicle including an acceleration sensor that detects an acceleration in the longitudinal direction of the vehicle, and further comprises a weight calculation unit that calculates, when the vehicle travels straight ahead, weight of the vehicle based on the thrust calculated by the thrust calculation unit and the acceleration in the longitudinal direction detected by the acceleration sensor.

5. The vehicle control device according to claim 3, wherein
the vehicle control device is applied to the vehicle including a yaw rate sensor that detects a yaw rate of the vehicle, and further comprises:
a moving velocity calculation unit that calculates moving velocities of the right and left drive wheels when the vehicle travels while turning; and
a tread calculation unit that calculates a tread of the vehicle based on the moving velocities of the right and left drive wheels calculated by the moving velocity calculation unit and the yaw rate detected by the yaw rate sensor.

6. The vehicle control device according to claim 1, wherein
the vehicle is an autonomous travel vehicle that autonomously travels based on traveling command values that are respectively command values of a speed, an acceleration in a longitudinal direction, and a yaw rate of the vehicle,
the vehicle control device further comprises a thrust prediction unit that predicts, when the vehicle is caused to travel based on the traveling command values, a thrust produced by rotation of the motors of the drive wheels based on the traveling command values, based on the position of the center of gravity of the vehicle calculated by the center of gravity calculation unit; and
if the thrust predicted by the thrust prediction unit exceeds a predetermined limit value, the control unit limits the rotational speeds or the moving velocities of the drive wheels.

7. The vehicle control device according to claim 6, wherein
when the vehicle is caused to travel straight ahead by the traveling command values,
the thrust prediction unit predicts, as a first thrust, the thrust produced by rotation of the motors of the drive wheels based on the traveling command values, based on a position of the center of gravity of the vehicle in a horizontal direction, and
if the first thrust exceeds the predetermined limit value, the control unit limits the rotational speeds or the moving velocities of the drive wheels, and
when the vehicle is caused to travel while turning by the traveling command values,
the thrust prediction unit predicts, as a second thrust, the thrust produced by rotation of the motors of the drive wheels based on the traveling command values, based on a position of the center of gravity of the vehicle in a longitudinal direction, and
if the second thrust exceeds the predetermined limit value, the control unit limits the rotational speeds or the moving velocities of the drive wheel.

8. The vehicle control device according to claim 7, wherein
the vehicle control device is applied to the vehicle including a yaw rate sensor that detects a yaw rate of the vehicle,
the thrust calculation unit calculates the thrust produced by rotation of the motors of the drive wheels in a state in which the pair of drive wheels are rotated in directions opposite to each other,
the vehicle control device further comprises an inertia calculation unit that calculates a rotary inertia of the vehicle based on a sum of the thrusts of the drive wheels obtained when the pair of drive wheels are rotated in directions opposite to each other and a differential value of the yaw rate detected by the yaw rate sensor, and
when the vehicle is caused to travel while turning by the traveling command values, the thrust prediction unit predicts the second thrust based on the traveling command values, the position of the center of gravity of the vehicle in the longitudinal direction, and the rotary inertia calculated by the inertia calculation unit.

9. The vehicle control device according to claim 1, wherein
the vehicle control device is applied to the vehicle that includes a yaw rate sensor detecting a yaw rate of the vehicle and is capable of changing direction by rotating the pair of drive wheels in directions opposite to each other,
the thrust calculation unit calculates the thrust produced by rotation of the motors of the drive wheels in a state in which the pair of drive wheels are rotated in directions opposite to each other,
the vehicle control device further comprises:
an inertia calculation unit that calculates a rotary inertia of the vehicle based on a sum of the thrusts of the drive wheels obtained when the pair of drive wheels are rotated in directions opposite to each other and a differential value of the yaw rate detected by the yaw rate sensor; and
a prediction unit that predicts, when the vehicle is caused to change direction based on a yaw rate command value, a thrust produced by rotation of the motors of the drive wheels based on the yaw rate command value, based on the yaw rate command value and the rotary inertia calculated by the inertia calculation unit, and
if the thrust predicted by the prediction unit exceeds a predetermined limit value, the control unit limits the rotational speeds or the moving velocities of the drive wheels.

10. A vehicle control method that is applied to a vehicle including: a vehicle body; a pair of drive wheels that are mounted to the vehicle body at two positions, which are right and left positions with respect to a traveling direction, and respectively have motors that are independently driven; and steerable driven wheels mounted to the vehicle body, the vehicle control method controlling drive of the motors of the drive wheels to control travel of the vehicle,
the method comprising:
a thrust calculation step of calculating a thrust produced by rotation of the motors at the drive wheels when the vehicle travels on a predetermined path;
a center of gravity calculation step of calculating a position of a center of gravity of the vehicle in a coordinate system whose origin is a center position between the pair of drive wheels, based on the thrust calculated by the thrust calculation unit; and
a control step of controlling rotational speeds or moving velocities of the drive wheels based on the position of the center of gravity.
